(19) United States
(12) Patent Application Publication
(10) Pub. No.: US 2002/0173553 A1
(43) Pub. Date: Nov. 21, 2002

(54) Zein coated xanthan for improved dispersion and hydration

(76) Inventors: You-Lung Chen, San Diego, CA (US); Akiva Gross, San Diego, CA (US); Ronnie Yuan, San Diego, CA (US); Todd Talashek, San Diego, CA (US)

Correspondence Address: BANNER & WITCOFF, 1001 G STREET N W, SUITE 1100, WASHINGTON, DC, 20001, US

(21) Appl. No.: 09/855,756

(22) Filed: May 16, 2001

(51) Int. Cl. C09K 3/00

(52) U.S. Cl. 516/70

(57) ABSTRACT

A composition comprising xanthan gum particles coated with a mixture of zein (corn protein) and at least one emulsifier. The surface coating improves the dispersion and hydration of xanthan gum resulting in shorter mix times for the user of the xanthan gum. Moreover, the xanthan gum powder dispersibility and hydration properties may be tailored by modifying the amounts of the zein and emulsifier in the coating blend. In addition, there is a significant fine particle reduction with the coated xanthan gum.

### FIELD OF THE INVENTION

The invention is directed to zein coated xanthan gum particles.

### BACKGROUND OF THE INVENTION

Xanthan gum is a synthetic, water soluble biopolymer derived from the fermentation of carbohydrates by several bacterial species of the genus Xanthomonas. It is useful as a thickening and suspension agent in numerous applications. It is tolerant in both strongly acidic and basic conditions and is also heat stable; thus it is useful in many chemical, pharmaceutical and, in particular, food applications such as dairy products, beverages, and high protein foods.

Xanthan gum tends to form fish-eyes or lumps when added to solution. Thus, xanthan gum displays poor wettability properties and is difficult to disperse in water and/or to hydrate. There have been some efforts to alleviate this problem. U.S. Pat. Nos. 5,633,028 and 5,728,825 combine xanthan gum with a surfactant to provide a dust-free hydratable xanthan gum composition. U.S. Pat. No. 5,728,825 further adds a chelating salt.

Coating xanthan powder with a surfactant having a high HLB value, such as Polysorbate 60, results in a powder that has poor flow properties due to the tendency of the particles to adhere to one another. The poor flow properties of the surfactant treated xanthan powder make it difficult to transport the product. Such poor flow properties cause problems with food processing equipment at the manufacturer's sites.

It is desirable to treat xanthan gum in such a way to avoid fish-eyes or lumps when adding the gum into solution as well as maintain good flow properties of the particles.

### BRIEF SUMMARY OF THE INVENTION

It was discovered that xanthan gum particles coated with zein and an emulsifier disperses and hydrates better than xanthan gum alone. The coating prevents fish-eyes or lumps when the coated xanthan gum is added to an aqueous solution. The coating also reduces the amount of fine particles of xanthan gum powder.

The invention is therefore directed to xanthan gum particles coated with zein. Zein is the generic name of the protein found in corn that does not contain the amino acids lysine or tryptophan. The zein may be used in crude or purified form.

The invention is also directed to xanthan gum particles coated with zein and an emulsifier. The zein and emulsifier coating improves the dispersion and hydration of xanthan gum, resulting in shorter mix times for the user of the xanthan gum. This further allows increased throughput rates. Moreover, dispersibility and hydration properties of the xanthan gum powder may be tailored by modifying the amounts of the zein and food grade emulsifier in the coating blend.

### BRIEF DESCRIPTION OF THE DRAWINGS

FIG. 1 depicts the effect of a zein surface coating on xanthan hydration.

FIG. 2 shows a comparison of cumulative particle size distribution of xanthan gum and xanthan gum coated with 1% zein.

FIG. 3 shows a comparison of particle size distribution of xanthan gum and xanthan gum coated with 1% zein.

FIG. 4 depicts the effects of different surface coating conditions on xanthan hydration.

FIG. 5 depicts the effects of different surface coating conditions on xanthan hydration.

### DETAILED DESCRIPTION OF THE INVENTION

The present invention is directed to xanthan gum particles having a coating of zein, preferably a coating of zein and an emulsifier. Zein is a very hydrophobic protein, which inhibits the wettability of the xanthan powder, acting to slightly retard hydration, thus improving dispersion. The zein may be purified (more expensive) or non-purified (crude).

The xanthan gum particles are coated in any suitable manner. For example, xanthan gum particles are immersed into an alcohol/water solution of zein and emulsifier. The alcohol/water solution is then removed, for example by heating the solution.

The alcohol may be any suitable alcohol such as isopropyl alcohol, ethanol, propanol, or butanol. The alcohol/water mixture may be 40% to 95% alcohol to 60% to 5% water. A typical ratio of alcohol to water is about 80 to 20 (w/w). The zein and emulsifier are dissolved in the alcohol/water solution in a ratio of IPA/water to zein/emulsifier 80 of about 100 to about 4 to 1, preferably about 20 to about 6 to 1, more preferably about 10 parts to 1.

The coating is applied to the xanthan gum in an amount to provide about 0.05 wt % to about 5 wt % based on the xanthan gum weight, preferably about 0.2 wt % to about 2.0 wt %, more preferably about 0.3 wt % to about 1.5 wt %. The amounts of the zein and emulsifier in the coating blend may be modified to tailor the xanthan gum powder flowability, dispersibility, and hydration properties.

Xanthan gum is synthesized using bacteria belonging to the genus Xanthomonas and more particularly to the species described in Bergui's manual of Determinative Bacteriology, 8th edition, Williams and Wilkins Co., Baltimore (1974). Of the different species of Xanthomonas gums which may be used to synthesize the xanthan gum powder of the present invention, the species Xanthomonas campestris is particularly preferred.

The preparation of xanthan gum from a fermentation broth is described in many publications and in many patents. See, for example, U.S. Pat. Nos. 3,020,206; 3,020,207; 3,391,060; and 4,154,654. Typically, the polysaccharide is isolated from the fermentation broth by evaporation, drying and grinding, or by precipitation with a lower alcohol, separation of the liquid, drying and grinding such as to provide a powder. The commercially available powders have a particle size typically ranging from about 1-500 microns. The xanthan gum particles are preferably about 1 μm to about 1000 μm in diameter, more preferably about 5 μm to about 500 μm.

The emulsifier preferably has a high hydrophilic/lipophilic balance (HLB) value, preferably greater than 10. Suitable emulsifiers include those approved for use in foods since many of the applications for the present invention reside in the food and drug industries. Preferably, the emulsifier is selected from the group consisting of polyoxyethylene sorbitan esters, sorbitan esters, monoglycerides, lecithin, polyglycerols, sodium stearoyl-2-lactylate, stearyl-2-lactylic acid, polyoxystearates, acetylated monoglycerides and mixtures thereof. Preferably, sorbitan esters and polyoxyethylene sorbitan esters are the emulsifiers of choice. Suitable emulsifiers include Tween 80.

The coated xanthan particles demonstrate excellent dissolution properties when hydrated. Because of their thickening properties and their rheology, the zein coated xanthan gum particles have a variety of applications, including, but not limited to foodstuffs and uses in the building, paint, paper, textile, cosmetic and plant protection chemical industries, in water treatment and in the petroleum industry, for example, in the drilling and the enhanced recovery of oil.

A particularly preferred use for the zein coated xanthan particles is in foodstuffs such as salad dressings, sauces, and beverages. Applicants have surprisingly found that when utilizing the coated xanthan gum particles and distributing it in an aqueous solution, the resulting composition easily disperses and hydrates, forming a homogeneous solution. This is in sharp contrast to prior art compositions which can form lumps when distributed in solution. The presence of lumps indicates that the xanthan gum composition does not adequately disperse and fully dissolve into the solvent. The zein coated xanthan powder does have some negative impact on powder flow properties. However, the effect is not as severe as observed for powder coated with surfactants such as Polysorbate 60.

The following examples are disclosed to more specifically describe the embodiments of the present invention. They are for illustrative purposes only however, and should not be construed as limiting the spirit and scope of the invention as recited by the claims that follow.

### EXAMPLE 1

Xanthan gum particles were coated with a solution of zein and Tween 80. First, zein and Tween 80 were dissolved in an isopropyl alcohol (IPA)/water mixture at 80/20 (w/w). The ratio of IPA/water to zein/Tween 80 was about 10 parts to 1. The IPA/water solution was added to the xanthan gum particles and blended for about 15 minutes. The coated xanthan gum particles were then placed in a 50° C. oven for 30 minutes to remove excess IPA and water. The coated xanthan gum particles had either 0.5% or 1% coating by weight based on xanthan gum weight.

### EXAMPLE 2

A CP Kelco Hydration Rate Tester was used to evaluate the xanthan gum's hydration performance. One gram of sieved xanthan gum (powder mesh size: though 100 mesh on 200 mesh) was added to a 1% NaCl solution in the hydration test. The test procedure was based on the hydration rate test protocol. The following four test conditions were used to test the hydration properties of coated xanthan gum particles in an aqueous 1% sodium chloride solution.

1. Predispersed xanthan gum control using a 3:1 ratio of PEG 300 to uncoated xanthan powder

2. Undispersed, uncoated xanthan gum control

3. Xanthan gum coated with 0.5% zein (no dispersant)

4. Xanthan gum coated with 1.0% zein (no dispersant)

The results are shown in FIG. 1. Sample 1 represents a well-dispersed control where formation of lumps and fisheyes has been minimized by predispersing the xanthan gum powder in a large amount of the dispersant PEG 300. Sample 2, without proper surface treatment and without a dispersant, formed fish-eyes or lumps during the addition of gum into the solution and resulted in slower or incomplete hydration. In contrast, samples 3 and 4 dispersed and hydrated better than control sample 2, but did not disperse as well as sample 1, which was predispersed in a large volume of PEG 300 to inhibit fisheye formation.

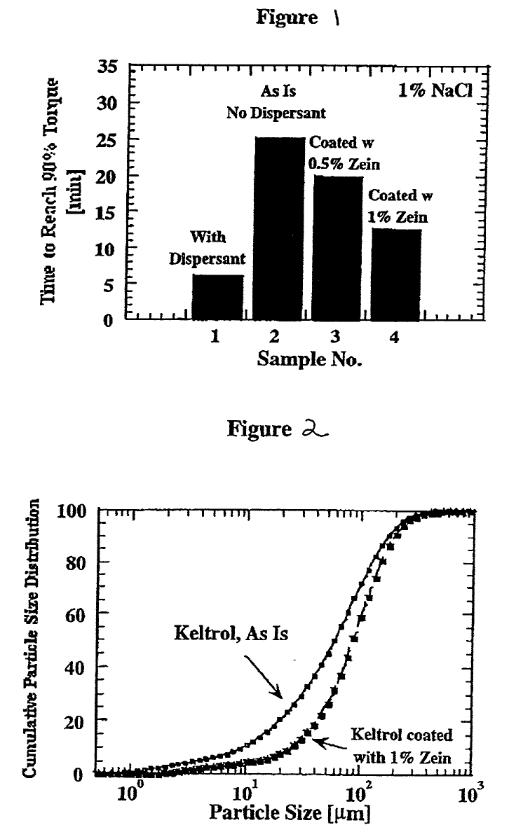

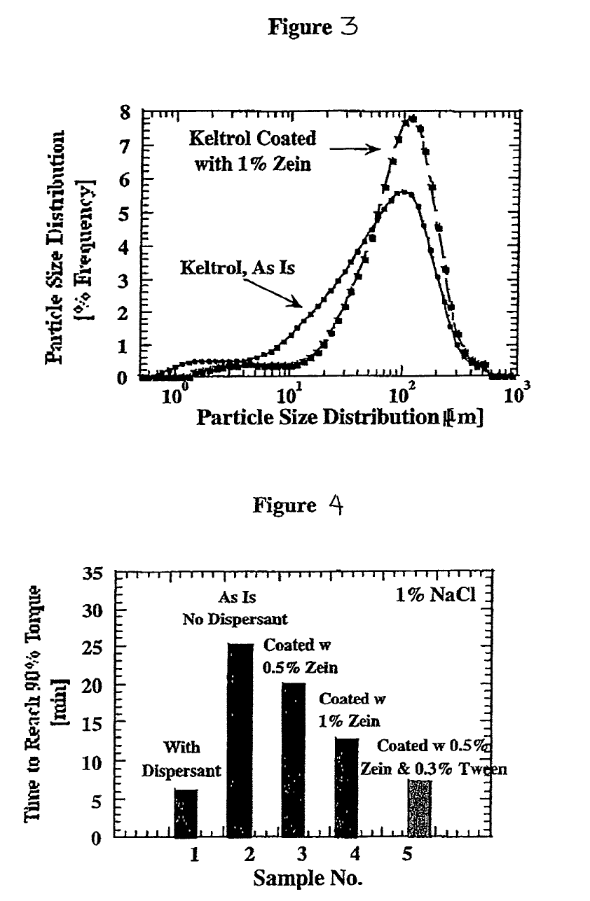

The xanthan gum particles coated using a zein and IPA/water solution also provided fine particle reduction. FIGS. 2 and 3 showed particle size distribution (PSD) and cumulative PSD before and after the zein surface coating process. Although the fine particles were not completely eliminated, there was a significant reduction of fine size particles (>50%).

### EXAMPLE 3

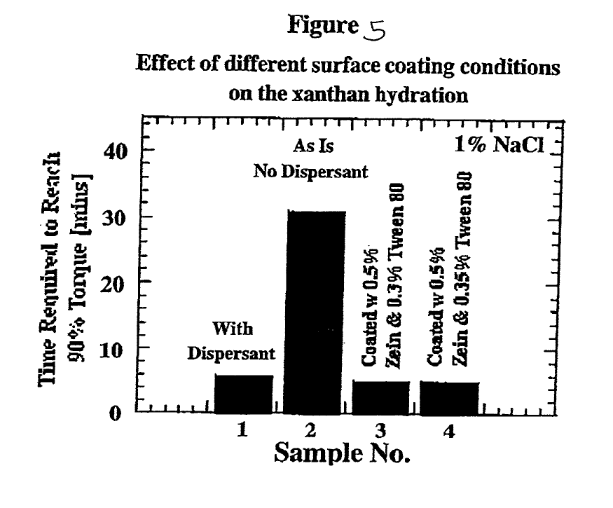

A hydrophilic co-agent (emulsifier), Tween 80, was added to improve the surface wettability and therefore hydration properties of the zein coated xanthan gum particles. FIG. 4 provides the results of adding an emulsifier. Samples 1-4 were compared with Sample 5 containing xanthan gum coated with 0.5% zein and 0.3% Tween 80. The addition of 0.3 wt % Tween 80 significantly improved the hydration and dispersion properties of the xanthan gum particles by improving the wettability of the zein surface coating. Xanthan gum particles coated with zein and Tween 80 displayed good powder flowability, dispersability, and hydration characteristics.

### EXAMPLE 4

The following four test conditions were used to test the dispersion/hydration properties of coated xanthan gum particles in an aqueous 1% sodium chloride solution.

1. Xanthan gum control with PEG 300 dispersant

2. Xanthan gum control without dispersant

3. Xanthan gum coated with 0.5% zein and 0.3% Tween 80 (no dispersant)

4. Xanthan gum coated with 1.0% zein and 0.35% Tween 80 (no dispersant)

The results are shown in FIG. 5. Sample 2, having no proper surface treatment and without the use of a dispersant, formed fish-eyes or lumps during the addition of gum into solution resulting in much slower and/or incomplete hydration. In contrast, samples 3 and 4 having xanthan gum particles coated with zein and Tween 80, dispersed and hydrated much better than control sample 2. Moreover, a significant fine particle reduction was observed for the xanthan gum particles coated with zein and Tween 80.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A composition comprising xanthan gum particles coated with zein.

2. The composition of claim 1 wherein the zein is present in an amount of from about 0.1% to about 5% by weight of the total weight of the xanthan gum.

3. The composition of claim 2 wherein the zein and at least one emulsifier are present in an amount of from about 0.2% to about 1.5% by weight of the total weight of the xanthan gum.

4. A composition comprising xanthan gum particles coated with a mixture of zein and at least one emulsifier.

5. The composition of claim 4 wherein the emulsifier is a food grade emulsifier.

6. The composition of claim 4 wherein the emulsifier has a hydrophilic/lipophilic balance value greater than 10.

7. The composition of claim 6 wherein the emulsifier is selected from the group consisting of polyoxyethylene sorbitan esters, sorbitan esters, acetylated monoglycerides, glycerol esters, lecithin, monoglycerides, sodium steroyl-2-lactylate, polyglycerol esters, propylene glycol esters, stearyl-2-lactylic acid and mixtures thereof.

8. The composition of claim 4 wherein the emulsifier is selected from the group consisting of polyoxyethylene sorbitan esters and sorbitan esters.

9. The composition of claim 8 wherein the emulsifier is polyoxyethylene sorbitan monostearate.

10 The composition of claim 4 wherein the zein and at least one emulsifier are present in an amount of from about 0.1% to about 5% by weight of the total weight of the xanthan gum.

11. The composition of claim 10 wherein the zein and at least one emulsifier are present in an amount of from about 0.2% to about 1.5% by weight of the total weight of the xanthan gum.

12. The composition of claim 1 prepared by dissolving the zein in alcohol and water to form a solution; coating the xanthan gum particles with the solution; and heating to remove the water and alcohol.

13. The composition of claim 12 wherein the alcohol is isopropyl alcohol, ethanol, propanol, or butanol.

14. The composition of claim 4 prepared by dissolving the zein and the at least one emulsifier in alcohol and water to form a solution; coating the xanthan gum particles with the solution; and heating to remove the water and alcohol.

15. The composition of claim 14 wherein the alcohol is isopropyl alcohol, ethanol, propanol, or butanol.

16. A method of producing coated xanthan gum particles comprising dissolving zein and at least one emulsifier in a solution comprising water and alcohol; coating xanthan gum particles with the solution; and heating to remove the water and alcohol.

17. A method of producing coated xanthan gum particles comprising dissolving zein in a solution comprising water and alcohol; coating xanthan gum particles with the solution; and heating to remove the water and alcohol.

18. An aqueous solution comprising the zein coated xanthan gum particles of claim 4 and water.
